(19) United States
(12) Patent Application Publication
(10) Pub. No.: US 2026/0122167 A1
(43) Pub. Date: Apr. 30, 2026

(54) Projector for Phone Device

(71) Applicant: Brian Lausmann, Lisle, IL (US)

(72) Inventor: Brian Lausmann, Lisle, IL (US)

(21) Appl. No.: 19/214,165

(22) Filed: May 21, 2025

Related U.S. Application Data
(60) Provisional application No. 63/713,222, filed on Oct. 29, 2024.

(51) Int. Cl. H04M 1/02; G03B 21/14; G03B 29/00; G06F 3/04847; G06F 3/16

(52) U.S. Cl. CPC H04M 1/0272; G03B 21/145; G03B 29/00; G06F 3/04847; G06F 3/165; G06F 3/167; H04M 1/0249

(57) ABSTRACT

A projector for smart phone device is disclosed, which projects the screen from a smart phone onto a wall or ceiling. The projector for smart phone device can be wireless or attached by a cord and is synced with the smart phone via Bluetooth and controlled by the user through the smart phone. The device comprises an integrated speaker and microphone for voice commands, for allowing complete hands-free use, if desired. Further, the device includes lenses which rotate to project on various ceilings or walls and easy-to-use perspective and focus controls. The device also includes a power button, volume controls, and a focus slider ring for focusing the projected image.

### CROSS-REFERENCE TO RELATED APPLICATION

The present application claims priority to, and the benefit of, U.S. Provisional Application No. 63/713,222, which was filed on Oct. 29, 2024, and is incorporated herein by reference in its entirety.

### FIELD OF THE INVENTION

The present invention relates generally to the field of projector for smart phone devices. More specifically, the present invention relates to a projector which projects cell phone content onto the ceiling or other wall surface. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in projector for smart phone devices. Generally, while lying down looking at a phone, a user can develop hand fatigue and eye strain. Further, trying to hold a phone when in a prone position can be the opposite of relaxing, as keeping the device over the head tires out both the arms and the eyes.

Furthermore, the popularity of cell phones brings more entertainment for people, now, cell phones are not only limited to have phone calls and send or receive messages, and but also used to watch movies, listen to music and surf on the internet, chat on video, etc. Thus, the cell phone with more various functions, brings infinite convenience to users. However, during the course of using cell phones, it is inconvenient to allow multiple people to watch the screen due to the smaller size of the screen.

Accordingly, there is a demand for an improved projector for smart phone device that allows users to project the screen from a smart phone onto a wall or ceiling. More particularly, there is a demand for a projector for smart phone device that includes an integrated speaker and microphone for hands-free use.

Therefore, there exists a long felt need in the art for a projector for smart phone device that provides users with a projector to project cell phone content onto the ceiling. There is also a long felt need in the art for a projector for smart phone device that is wireless or has an attached cord. Further, there is a long felt need in the art for a projector for smart phone device that allows a user to control the device through their smart phone. Moreover, there is a long felt need in the art for a device that includes an integrated speaker and microphone allowing complete hands-free use. Further, there is a long felt need in the art for a projector for smart phone device that prevents eye strain and reduces arm and hand fatigue. Finally, there is a long felt need in the art for a projector for smart phone device that includes lenses that rotate to project on various ceilings or walls.

The subject matter disclosed and claimed herein, in one embodiment thereof, comprises a projector for smart phone device. The device projects the screen from a smart phone onto a wall or ceiling. The projector for smart phone device can be wireless or attached by a cord and is synced with the smart phone via Bluetooth and controlled by the user through the smart phone. The device comprises an integrated speaker and microphone for voice commands, for allowing complete hands-free use, if desired. Further, the device includes lenses which rotate to project on various ceilings or walls and easy-to-use perspective and focus controls. The device also includes a power button, volume controls, and a focus slider ring for focusing the projected image.

In this manner, the projector for smart phone device of the present invention accomplishes all of the forgoing objectives and provides users with a projector for a smart phone that prevents eye strain and reduces arm and hand fatigue. The device syncs to a phone via Bluetooth. The device comprises various controls for use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a projector for smart phone device. The device projects the screen from a smart phone onto a wall or ceiling. The projector for smart phone device can be wireless or attached by a cord and is synced with the smart phone via Bluetooth and controlled by the user through the smart phone. The device comprises an integrated speaker and microphone for voice commands, as well as includes lenses which rotate to project on various ceilings or walls and easy-to-use perspective and focus controls.

In one embodiment, the projector for smart phone device projects the screen from a smart phone onto a wall or ceiling to prevent eye strain and reduce arm and hand fatigue. The device is a wireless mini projector that allows users to project their smart phone's display onto any surface, for a more comfortable viewing experience. The projector for smart phone device wirelessly syncs with linked smart devices via Bluetooth and helps reduce blue light exposure.

In one embodiment, the projector for smart phone device comprises a housing component for enclosing the device's components. The housing component can be any suitable shape and size as is known in the art. In the present embodiment, the housing component is rounded in shape at the top for projecting the image from the top and flat at the bottom for allowing the housing component to rest securing on a surface and not shift during use.

In one embodiment, the housing component comprises components, such as a microprocessor and transceiver which is compliant and compatible with existing mobile telephone (cellular and smart phone) protocols and infrastructures. In one embodiment, the housing component utilizes a wireless communication protocol or RF standard, such as Bluetooth or an Ultra Low Power (ULP) Bluetooth protocol, or other wireless protocol to enable communication between the smart device and the housing component. In this embodiment, the device wirelessly syncs with linked smart phones. Once synced, the user can navigate their smart phone to find the video, movie, television show, etc. they want to project. The user can then send an activation signal to the projector device to project the desired show, video, movie, etc. Further, the projector device can be controlled by the user through the synced smart device.

In one embodiment, the housing component incorporates a minimum amount of communications circuitry which may be imbedded or integrated into the housing component. For example, the housing component can minimally include a processor, transceiver, memory, a power source such as a long-life battery, and an antenna which is integrated into the housing component. With additional innovations in battery technology, batteries such as lithium-ion batteries can be provided which allows for the housing component to operate for relatively long time periods. In another embodiment, the housing component comprises an electrical plug that can be plugged into a conventional wall socket for powering the device.

In one embodiment, the housing component comprises an antenna coupled to an RF transceiver device. The transceiver, processor, and memory each receive power from a power source, such as a battery. Components such as an antenna, a transceiver, a processor, and a memory can vary according to those known in the art and used in mobile devices such as cellular and smart phones. An exemplary housing component may receive an activation signal via the antenna and through the transceiver which is registered by the processor. As a next step, the processor may interrogate the memory for specific identification information assigned in the memory. For example, the housing component identifies each smart device that is connected to it for projection.

In one embodiment, the housing component also comprises a power control button for powering on and off the device. The housing component further provides a speaker with integrated microphone for voice commands, allowing for complete hands-free use of the device. The housing component also comprises volume control buttons, that allows a user to manually adjust the volume of the video, movie, television show, etc., as needed.

In one embodiment, the housing component comprises lenses that rotate for easy projection on both ceilings and walls. Specifically, the lenses can be manually moved or rotated from left to right along the curved top surface of the housing. Or the lenses can be mechanically rotated from left to right via a motor or other suitable mechanism as is known in the art.

In one embodiment, the housing component comprises easy-to-use perspective and focus controls. Specifically, the housing component can comprise a focus slider ring that allows a user to rotate the ring clockwise and counterclockwise to change and alter focus of the projection. Further, the housing component also comprises perspective controls which allow a user to toggle the buttons right and left to change and alter the perspective of the projection, to allow a user to see more clearly the video, movie, or television show, etc., which is projected.

In one embodiment, the power source is a battery, typically a rechargeable battery that can be recharged via a USB port. In this embodiment, the USB port is positioned on the housing component in any suitable position as is known in the art.

In use, a video signal within the smart phone can be easily output through the projector device, to bring a better visual effect for users, and it is also convenient for user to watch the video and reduce eye strain and hand fatigue. Further, the housing component is then powered on via pressing the power buttons. The housing component is powered via an attached electrical cord or the rechargeable battery. The device is then synced with a paired smart device via Bluetooth or other suitable wireless connectivity. Once synced, the user can navigate their smart phone to find the video, movie, television show, etc. they want to project. The user can then send an activation signal to the projector device. The projector device receives the activation signal via the antenna and through the transceiver which is registered by the processor. As a next step, the processor may interrogate the memory for specific identification information assigned in the memory. For example, the housing component identifies the synced smart device that is connected to it for projection. If the smart device is verified by the projector device, the projector device projects the synced smart device's screen. The user can then adjust the projection via voice commands with the speaker and integrated microphone of the housing component. Further, the lenses can be rotated, as needed, to project the image on a ceiling or wall. Further, the user can adjust perspective and focus via the corresponding controls of the housing component, as well as can adjust the volume via volume controls. Thus, the projector for smart phone device makes it easy to project a smart device's screen onto ceilings or walls for a more comfortable viewing experience.

In yet another embodiment, the projector for smart phone device comprises a plurality of indicia.

In yet another embodiment, a method of projecting the screen of a smart phone onto a ceiling or wall is disclosed. The method includes the steps of providing a projector for smart phone device comprising a housing component with an integrated speaker and microphone. The method also comprises syncing the device with the smart phone. Further, the method comprises using the device to project the smart phone screen onto a ceiling or wall. The method also comprises adjusting focus, perspective, and volume as needed. The method comprises using the integrated speaker and microphone for voice commands. Finally, the method comprises watching the projected screen without eye strain and arm and hand fatigue.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the projector for smart phone device of the present invention in accordance with the disclosed architecture;

FIG. 2 illustrates a perspective view of one embodiment of the projector for smart phone device of the present invention showing the rotating lenses in accordance with the disclosed architecture;

FIG. 3 illustrates a perspective view of one embodiment of the projector for smart phone device of the present invention showing the power button and volume controls in accordance with the disclosed architecture;

FIG. 4 illustrates a perspective view of one embodiment of the projector for smart phone device of the present invention showing the perspective controls in accordance with the disclosed architecture;

FIG. 5 illustrates a perspective view of one embodiment of the projector for smart phone device of the present invention showing the focus slider ring control in accordance with the disclosed architecture;

FIG. 6 illustrates a perspective view of one embodiment of the projector for smart phone device of the present invention showing the speaker and integrated microphone in accordance with the disclosed architecture;

FIG. 7 illustrates a perspective view of one embodiment of the projector for smart phone device of the present invention showing the device in use in accordance with the disclosed architecture;

FIG. 8 illustrates a perspective view of one embodiment of the projector for smart phone device of the present invention showing the smart phone synced with the device in accordance with the disclosed architecture;

FIGS. 9A-C illustrate a perspective view of one embodiment of the projector for smart phone device of the present invention showing the device and its components in accordance with the disclosed architecture;

FIGS. 10A-C illustrate a perspective view of one embodiment of the projector for smart phone device of the present invention showing the device in use in accordance with the disclosed architecture; and

FIG. 11 illustrates a flowchart showing the method of projecting the screen of a smart phone onto a ceiling or wall in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a projector for smart phone device that provides users with a projector to project cell phone content onto the ceiling. There is also a long felt need in the art for a projector for smart phone device that is wireless or has an attached cord. Further, there is a long felt need in the art for a projector for smart phone device that allows a user to control the device through their smart phone. Moreover, there is a long felt need in the art for a device that includes an integrated speaker and microphone allowing complete hands-free use. Further, there is a long felt need in the art for a projector for smart phone device that prevents eye strain and reduces arm and hand fatigue. Finally, there is a long felt need in the art for a projector for smart phone device that includes lenses that rotate to project on various ceilings or walls.

The present invention, in one exemplary embodiment, is a novel projector for smart phone device. The device projects the screen from a smart phone onto a wall or ceiling. The projector for smart phone device can be wireless or attached by a cord and is synced with the smart phone via Bluetooth and controlled by the user through the smart phone. The device comprises an integrated speaker and microphone for voice commands, for allowing complete hands-free use, if desired. Further, the device includes lenses which rotate to project on various ceilings or walls and easy-to-use perspective and focus controls. The device also includes a power button, volume controls, and a focus slider ring for focusing the projected image. The present invention also includes a novel method of projecting the screen of a smart phone onto a ceiling or wall. The method includes the steps of providing a projector for smart phone device comprising a housing component with an integrated speaker and microphone. The method also comprises syncing the device with the smart phone. Further, the method comprises using the device to project the smart phone screen onto a ceiling or wall. The method also comprises adjusting focus, perspective, and volume as needed. The method comprises using the integrated speaker and microphone for voice commands. Finally, the method comprises watching the projected screen without eye strain and arm and hand fatigue.

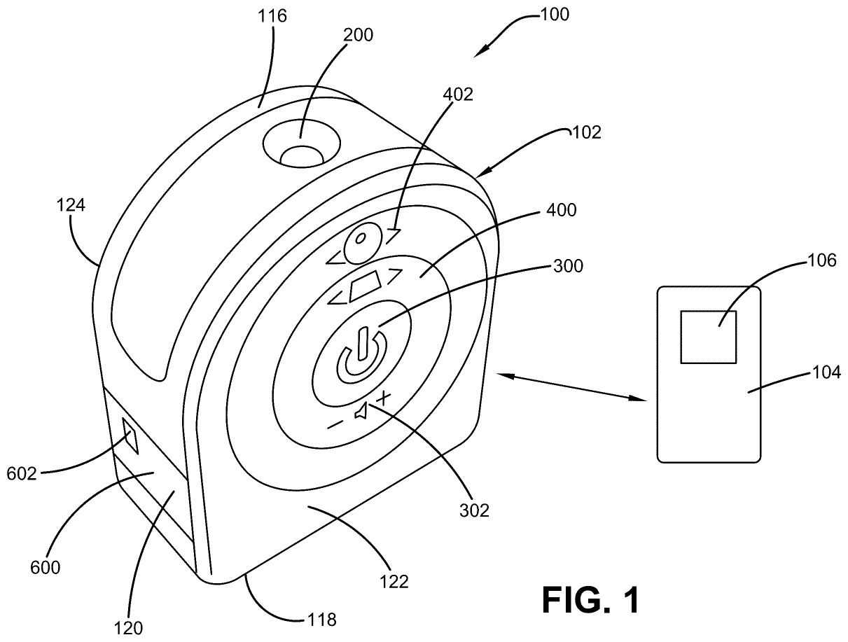

Referring initially to the drawings, FIG. 1 illustrates a perspective view of one embodiment of the projector for smart phone device 100 of the present invention. In the present embodiment, the projector for smart phone device 100 is an improved projector for smart phone device 100 that provides a user with a device for projecting a user's smart phone screen 106 onto a ceiling 108 and wall 110. Specifically, the projector for smart phone device 100 comprises a housing component 102 that can be wireless or attached by a cord 714 and is synced with a smart phone 104 via Bluetooth and controlled by the user through the smart phone 104.

Generally, the projector for smart phone device 100 projects the screen 106 from a smart phone 104 onto a wall 110 or ceiling 108 to prevent eye strain and reduce arm and hand fatigue. The device 100 is a wireless mini projector that allows users to project their smart phone's display (i.e., phone screen 106) onto any surface, for a more comfortable viewing experience. The projector for smart phone device 100 wirelessly syncs with linked smart devices 104 via Bluetooth and helps reduce blue light exposure.

Further, the projector for smart phone device 100 comprises a housing component 102 for enclosing the device's components. The housing component 102 can be any suitable shape and size as is known in the art, as long as the housing component 102 is sized and shaped to retain all the needed components and circuitry for projecting an image 114 from the smart phone 104. In the present embodiment, the housing component 102 comprises a top end 116, a bottom end 118, opposing side ends 120, a front surface 122, and a rear surface 124. Typically, the top end 116 is rounded in shape for projecting the image (i.e., projection 114) from the top and flat at the bottom end 118 for allowing the housing component 102 to rest securing on a surface and not shift during use.

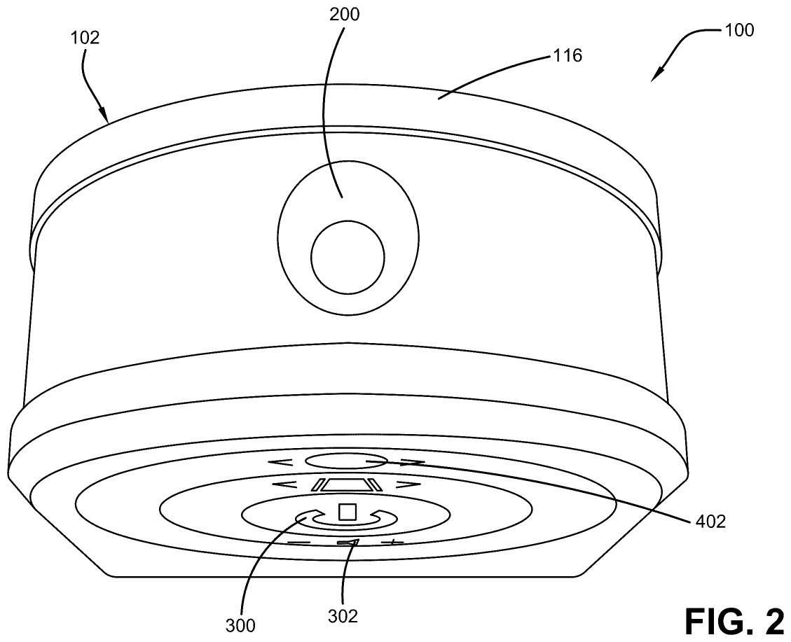

As shown in FIG. 2, the housing component 102 comprises lenses 200 that rotate for easy projection on both ceilings 108 and walls 110. Specifically, the lenses 200 can be manually moved or rotated from left to right along the curved top surface 116 of the housing component 102. In one embodiment, the lenses 200 can be mechanically rotated from left to right via a motor (not shown) or other suitable mechanism as is known in the art. Any suitable projector lenses 200 as is known in the art can be utilized, depending on the needs and/or wants of a user.

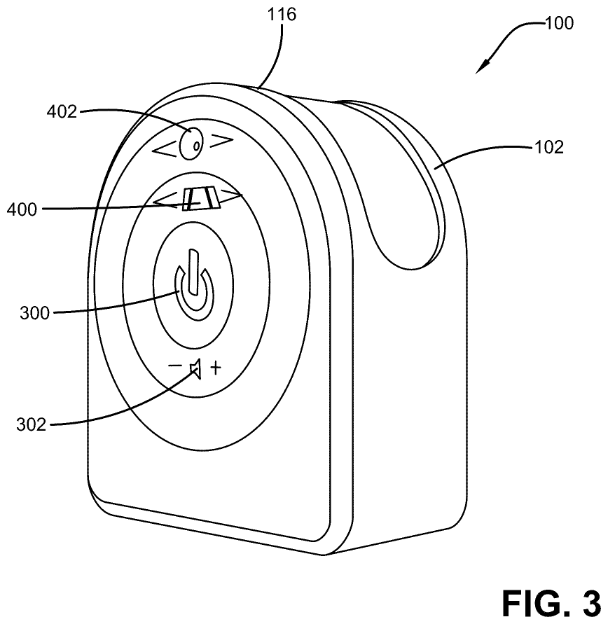

As shown in FIG. 3, the housing component 102 also comprises a power control button 300 for powering on and off the device 100. The housing component 102 also comprises volume control buttons 302, that allow a user to manually adjust the volume of the video, movie, television show, etc., projected on the ceiling 108 or wall 110, as needed. Further, the housing component 102 can include any other control buttons as deemed necessary for operating the device 100.

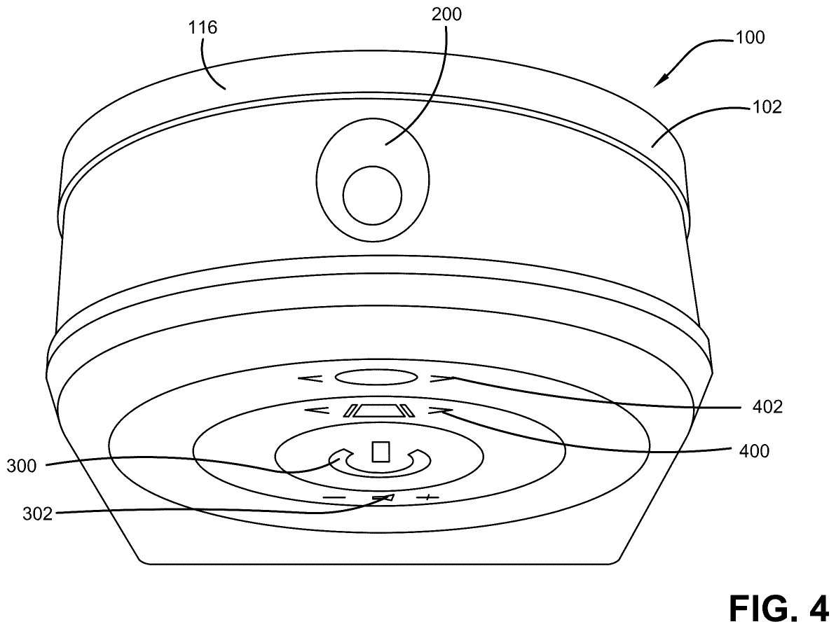

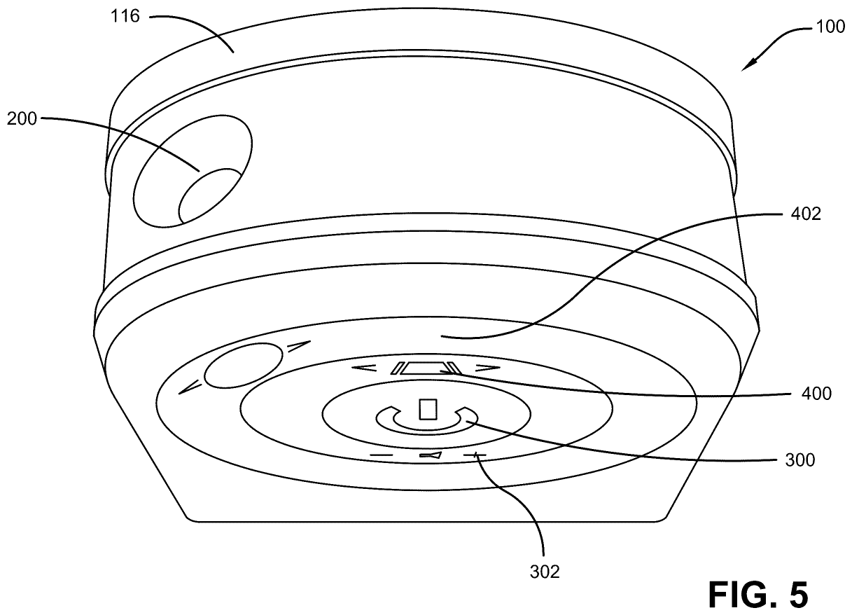

As shown in FIGS. 4-5, the housing component 102 comprises easy-to-use perspective 400 and focus 402 controls. Specifically, the housing component 102 can comprise a focus slider ring 402 that allows a user to rotate the ring 402 clockwise and counterclockwise to change and alter, as well as increase or decrease the focus of the projection 114. Further, the housing component 102 also comprises perspective controls 400 which allow a user to toggle the buttons 400 right and left to change and alter the perspective of the projection 114, to allow a user to see more clearly the video, movie, or television show, etc., which is projected.

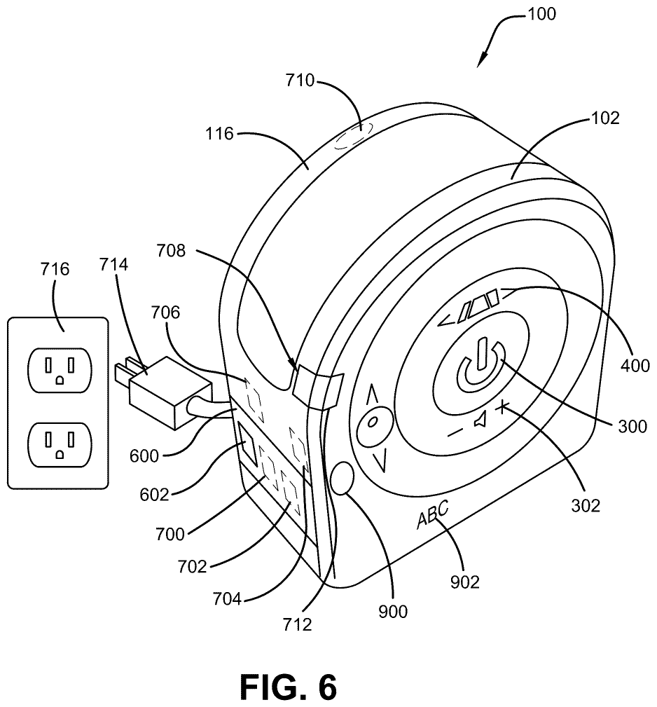

As shown in FIG. 6, the housing component 102 further provides a speaker 600 with integrated microphone 602 for voice commands, allowing for complete hands-free use of the device 100. Thus, users can speak voice commands into the microphone 602 to operate the device 100, as needed.

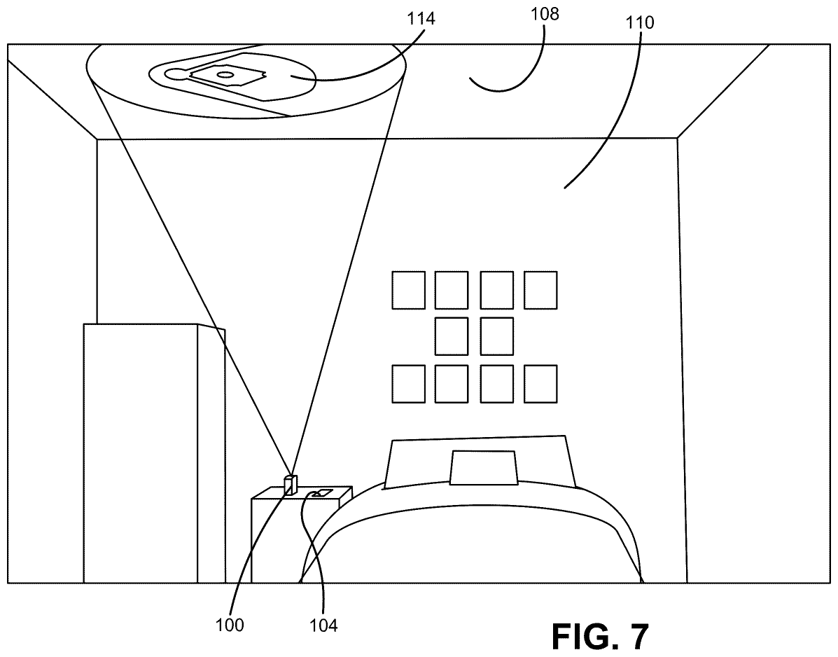

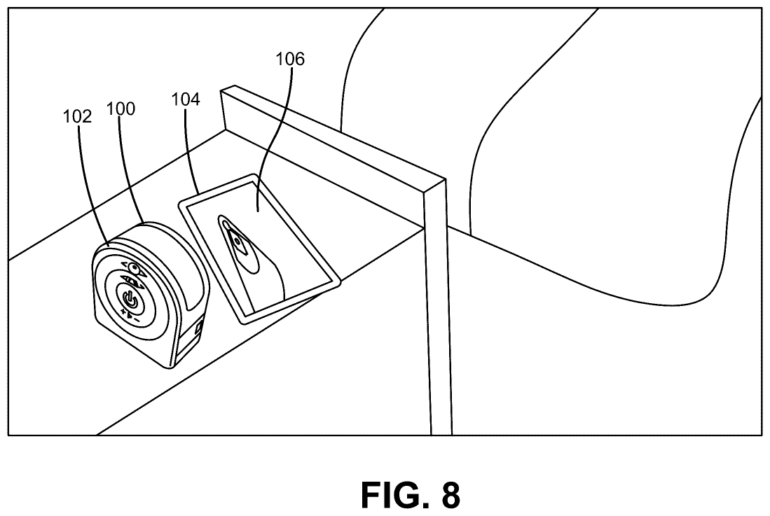

As shown in FIGS. 7-8, the housing component 102 comprises components, such as a microprocessor 700 and transceiver 702 which is compliant and compatible with existing mobile telephone (cellular and smart phone) protocols and infrastructures. In one embodiment, the housing component 102 utilizes a wireless communication protocol 704 or RF standard, such as Bluetooth or an Ultra Low Power (ULP) Bluetooth protocol, or other wireless protocol to enable communication between the smart device 104 and the housing component 102. In this embodiment, the device 100 wirelessly syncs with linked smart phones 104. Once synced, the user can navigate their smart phone 104 to find the video, movie, television show, etc. they want to project. The user can then send an activation signal to the projector device 100 to project the desired show, video, movie, etc. Further, the projector device 100 can be controlled by the user through the synced smart device 104.

Further, the housing component 102 incorporates a minimum amount of communications circuitry which may be imbedded or integrated into the housing component 102. For example, the housing component 102 can minimally include a processor 700, transceiver 702, memory 706, a power source 708 such as a long-life battery, and an antenna 710 which is integrated into the housing component 102. With additional innovations in battery technology, batteries 712 such as lithium-ion batteries can be provided which allows for the housing component 102 to operate for relatively long time periods. In another embodiment, the housing component 102 comprises an electrical plug 714 that can be plugged into a conventional wall socket 716 for powering the device 100.

Additionally, the housing component 102 comprises an antenna 710 coupled to an RF transceiver device 702. The transceiver 702, processor 700, and memory 706 each receive power from a power source 708, such as a battery 712. Components such as an antenna 710, a transceiver 702, a processor 700, and a memory 706 can vary according to those known in the art and used in mobile devices such as cellular and smart phones 104. An exemplary housing component 102 may receive an activation signal via the antenna 710 and through the transceiver 702 which is registered by the processor 700. As a next step, the processor 700 may interrogate the memory 706 for specific identification information assigned in the memory 706. For example, the housing component 102 identifies each smart device 104 that is connected to it for projection 114.

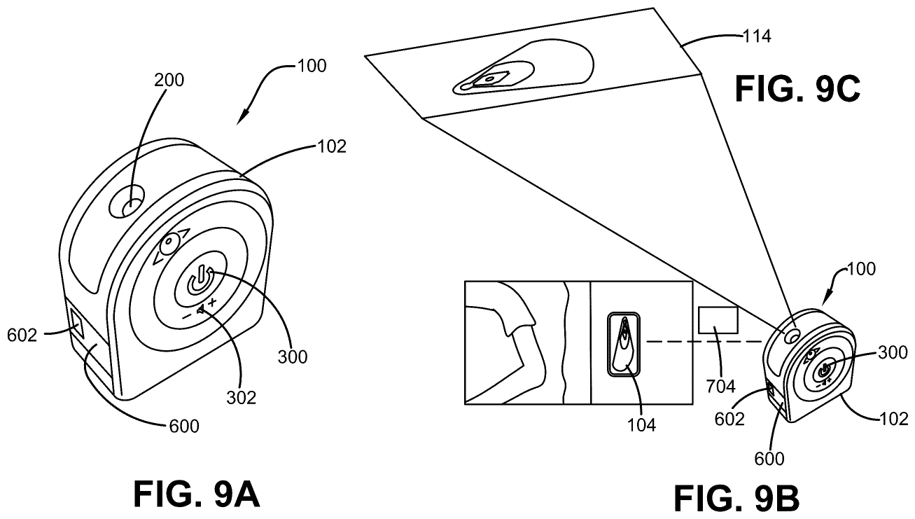

As shown in FIGS. 9A-C, the power source 708 is a battery 712, typically a rechargeable battery that can be recharged via a USB port 900. In this embodiment, the USB port 900 is positioned on the housing component 102 in any suitable position as is known in the art.

In one embodiment, the battery 712 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the projector for smart phone device 100. Throughout this specification, the term “battery” may be used interchangeably to refer to one or more wet or dry cells or batteries of cells in which chemical energy is converted into electricity and used as a source of DC power. References to recharging or replacing the battery 712 may refer to recharging or replacing individual cells, individual batteries of cells, or a package of multiple battery cells as is appropriate for any given battery technology that may be used. In addition, a rechargeable embodiment of the battery 712 may be recharged using a USB port 900, wherein the USB port is a USB-A, USB-B, Micro-B, Micro-USB, Mini-USB, or USB-C port, etc.

In yet another embodiment, the projector for smart phone device 100 comprises a plurality of indicia 902. The housing component 102 of the device 100 may include advertising, a trademark, or other letters, designs, or characters, printed, painted, stamped, or integrated into the housing component 102, or any other indicia 902 as is known in the art. Specifically, any suitable indicia 902 as is known in the art can be included, such as but not limited to, patterns, logos, emblems, images, symbols, designs, letters, words, characters, animals, advertisements, brands, etc., that may or may not be smart device 104, projector, or brand related.

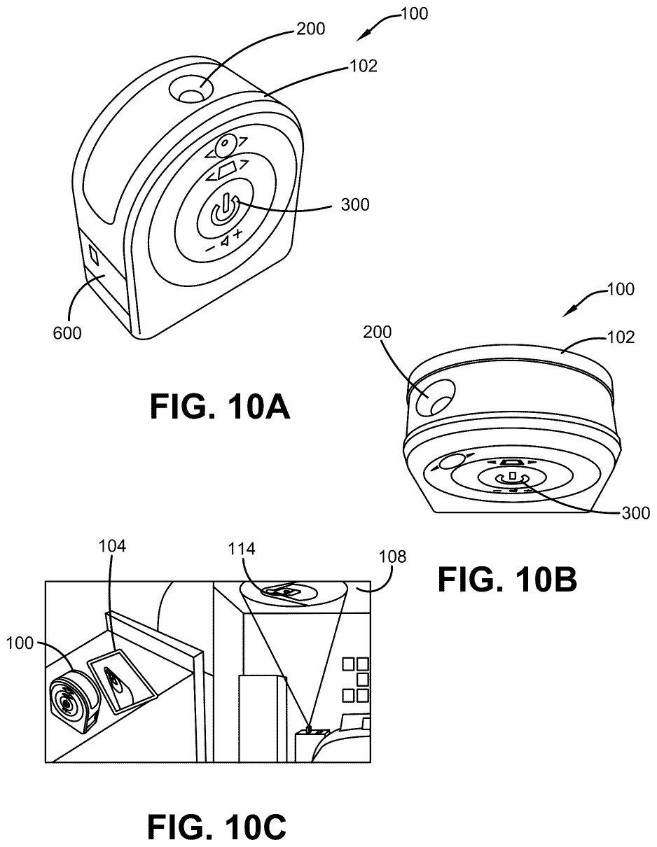

As shown in FIGS. 10A-C, in use, a video signal within the smart phone 104 can be easily output through the projector device 100, to bring a better visual effect for users, and it is also convenient for user to watch the video and reduce eye strain and hand fatigue. Further, the housing component 102 is then powered on via pressing the power buttons 300. The housing component 102 is powered via an attached electrical cord 714 or the rechargeable battery 712. The device 100 is then synced with a paired smart device 104 via Bluetooth or other suitable wireless connectivity 704. Once synced, the user can navigate their smart phone 104 to find the video, movie, television show, etc. they want to project. The user can then send an activation signal to the projector device 100. The projector device 100 receives the activation signal via the antenna 710 and through the transceiver 702 which is registered by the processor 700. As a next step, the processor 700 may interrogate the memory 706 for specific identification information assigned in the memory 706. For example, the housing component 102 identifies the synced smart device 104 that is connected to it for projection. If the smart device 104 is verified by the projector device 100, the projector device 100 projects the synced smart device's screen 106. The user can then adjust the projection 114 via voice commands with the speaker 600 and integrated microphone 602 of the housing component 102. Further, the lenses 200 can be rotated, as needed, to project the image 114 on a ceiling 108 or wall 110. Further, the user can adjust perspective controls 400 and focus controls 402 via the corresponding controls 400, 402 of the housing component 102, as well as can adjust the volume via volume controls 302. Thus, the projector for smart phone device 100 makes it easy to project a smart device's screen 106 onto ceilings 108 or walls 110 for a more comfortable viewing experience.

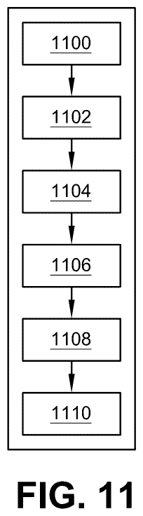

FIG. 11 illustrates a flowchart of the method of projecting the screen of a smart phone onto a ceiling or wall. The method includes the steps of at 1100, providing a projector for smart phone device comprising a housing component with an integrated speaker and microphone. The method also comprises at 1102, syncing the device with the smart phone. Further, the method comprises at 1104, using the device to project the smart phone screen onto a ceiling or wall. The method also comprises at 1106, adjusting focus, perspective, and volume as needed. The method comprises at 1108, using the integrated speaker and microphone for voice commands. Finally, the method comprises at 1110, watching the projected screen without eye strain and arm and hand fatigue.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “projector for smart phone device”, “projector device”, “smart phone device”, and “device” are interchangeable and refer to the projector for smart phone device 100 of the present invention.

Notwithstanding the forgoing, the projector for smart phone device 100 of the present invention can be of any suitable size and configuration as is known in the art without affecting the overall concept of the invention, provided that it accomplishes the above stated objectives. One of ordinary skill in the art will appreciate that the projector for smart phone device 100 as shown in FIGS. 1-11 is for illustrative purposes only, and that many other sizes and shapes of the projector for smart phone device 100 are well within the scope of the present disclosure. Although the dimensions of the projector for smart phone device 100 are important design parameters for user convenience, the projector for smart phone device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A projector for smart phone device that projects a smart phone screen onto a ceiling or wall, the projector for smart phone device comprising:
a housing component; and
a smart phone;
wherein the smart phone is synced to the housing component via Bluetooth; and
further wherein the housing component projects a screen of the smart phone onto a wall or ceiling for ease in viewing.

2. The projector for smart phone device of claim 1, wherein the housing component comprises a top end, a bottom end, opposing side ends, a front surface, and a rear surface.

3. The projector for smart phone device of claim 2, wherein the top end is rounded in shape for projecting an image and flat at the bottom end for allowing the housing component to rest securing on a surface and not shift during use.

4. The projector for smart phone device of claim 3, wherein the housing component comprises lenses that rotate for easy projection on both ceilings and walls.

5. The projector for smart phone device of claim 4, wherein the lenses are manually rotated from left to right along the curved top end of the housing component.

6. The projector for smart phone device of claim 5, wherein the housing component comprises a power control button for powering on and off the housing component.

7. The projector for smart phone device of claim 6, wherein the housing component comprises volume control buttons, that allow a user to manually adjust volume.

8. The projector for smart phone device of claim 7, wherein the housing component comprises a focus slider ring that allows a user to rotate the focus slider ring clockwise and counterclockwise to change and alter focus of the projected image.

9. The projector for smart phone device of claim 8, wherein the housing component comprises perspective controls which allow a user to toggle right and left to change and alter perspective of the projected image.

10. The projector for smart phone device of claim 9, wherein the housing component comprises a speaker with integrated microphone for voice commands, allowing for complete hands-free use of the projector for smart phone device.

11. The projector for smart phone device of claim 10, wherein the housing component comprises a microprocessor, a transceiver, a memory, a power source, and an antenna which are compliant and compatible with existing mobile telephone and smart phone protocols and infrastructures.

12. The projector for smart phone device of claim 11, wherein the housing component utilizes a wireless communication protocol or RF standard, such as Bluetooth to enable communication between the smart phone and the housing component, such that the projector for smart phone device wirelessly syncs with linked smart phones and allows a user to control the projector for smart phone device through the synced smart phone.

13. The projector for smart phone device of claim 12, wherein the housing component receives an activation signal via the antenna and through the transceiver, which is registered by the microprocessor, the microprocessor then interrogates the memory for specific identification information to identify each smart phone that is to be synced.

14. A projector for smart phone device that projects a smart phone screen onto a ceiling or wall, the projector for smart phone device comprising:
a housing component comprising a top end, a bottom end, opposing side ends, a front surface, and a rear surface; and
a smart phone;
wherein the top end is rounded in shape for projecting an image and flat at the bottom end for allowing the housing component to rest securing on a surface and not shift during use;
wherein the housing component comprises lenses that can be manually rotated for easy projection on both ceilings and walls;
wherein the housing component comprises a power control button, volume control buttons, a focus slider ring, perspective controls, and a speaker with integrated microphone;
wherein the housing component comprises a microprocessor, a transceiver, a memory, a power source, and an antenna which are compliant and compatible with existing mobile telephone and smart phone protocols and infrastructures;
wherein the smart phone is synced to the housing component via Bluetooth; and
further wherein the housing component projects a screen of the smart phone onto a wall or ceiling for ease in viewing.

15. The projector for smart phone device of claim 14, wherein the housing component receives an activation signal via the antenna and through the transceiver, which is registered by the microprocessor, the microprocessor then interrogates the memory for specific identification information to identify each smart phone that is to be synced.

16. The projector for smart phone device of claim 14, wherein the power source is a rechargeable battery.

17. The projector for smart phone device of claim 16, wherein the rechargeable battery is recharged via a USB port.

18. The projector for smart phone device of claim 14, wherein the housing component comprises an electrical plug that can be plugged into a conventional wall socket for power.

19. The projector for smart phone device of claim 14 further comprising a plurality of indicia.

20. A method of projecting the screen of a smart phone onto a ceiling or wall, the method comprising the following steps:
providing a projector for smart phone device comprising a housing component with an integrated speaker and microphone;
syncing the device with the smart phone;
using the device to project the smart phone screen onto a ceiling or wall;
adjusting focus, perspective, and volume as needed;
using the integrated speaker and microphone for voice commands; and
watching the projected screen without eye strain and arm and hand fatigue.
